(19) United States
(12) Patent Application Publication
(10) Pub. No.: US 2019/0088170 A1
(43) Pub. Date: Mar. 21, 2019

(54) WIRELESS, MULTI-COLORED DIAL-IN BOARD

(71) Applicant: Phineas Anthony Atchison, JR., Greenville, IL (US)

(72) Inventor: Phineas Anthony Atchison, JR., Greenville, IL (US)

(21) Appl. No.: 16/135,704

(22) Filed: Sep. 19, 2018

Related U.S. Application Data
(60) Provisional application No. 62/606,353, filed on Sep. 20, 2017.

(51) Int. Cl. G09F 13/22; G02F 1/1335

(52) U.S. Cl. CPC G09F 13/22; G09F 2013/227; G09F 2013/222; G02F 1/133603

(57) ABSTRACT

According to principles of the present inventive concepts, a dial-in board comprises a housing configured to house a digital display, a control module, and a rechargeable battery all within a single, portable, self-contained housing unit that mounts readily to a racing vehicle without the need for external wiring. The digital display is preferably a multi-colored LED display configured to display a dial-in time of the racing vehicle in any of multiple desired colors. A control module controls operation of the digital display, and the control module and the digital display are both powered by the rechargeable battery. The control module may further include a dimmer capable of controlling a brightness of the digital display. The control module may be controlled by a control panel arranged on the housing and/or through an external device that communicates with the control module wirelessly, such as through Bluetooth communication.

### PRIORITY CLAIM

### Priority Application Benefit Claim

This application is a non-provisional of, and claims priority from, U.S. Provisional Patent App. Ser. No. 62/606,353, filed Sep. 20, 2017, the contents of which are incorporated herein by reference in their entirety.

### BACKGROUND OF THE INVENTION

### Field of the Invention

This invention relates generally to dial-in boards (or “dial boards”) for drag racing, and particularly to digital dial-in boards designed to be mounted on a dragster or other vehicles that participate in handicap drag racing.

### Related Art

Dial-in boards are used on drag racing vehicles (including dragsters and other racing vehicles) to display a dial-in time for the vehicle. A dial-in time represents a time claiming how fast the vehicle is capable of completing the race course, and is used for handicapping drag races. If one vehicle's dial-in time is significantly slower than another's, the vehicles may be handicapped to make the race fair. Since the purpose of the dial-in time is to equalize races, if a racer beats his or her dial-in time, that racer is automatically disqualified.

Conventional digital dial-in boards may have a digital display mounted outside the dragster that is connected to a control box (or “control head”) located inside the vehicle via wiring. The conventional digital dial-in board is powered by the vehicle power source and requires a substantial amount of hardware and wiring to install on a vehicle. Furthermore, the conventional digital dial-in board is only capable of displaying a dial-in time in one color.

It is an object of the present inventive concepts to provide a digital dial-in board that is easily installed with minimal wiring and hardware, and which can display a dial-in time in any of multiple desired colors.

### SUMMARY OF THE INVENTION

According to various embodiments and principles of the present inventive concepts, a digital dial-in board provides a digital display of a dial-in time on a racing vehicle without the need for wiring to the vehicle's power source. Rather than connecting to the vehicles power supply, a digital dial-in board according to principles of these inventive concepts includes a rechargeable battery that can power the dial-in board for a length of time between charges (e.g., 8-10 hours or more on a full charge). Furthermore, rather than having separate and remote dial-in board and control heads, the display board and control module according to these inventive concepts may be contained in a single housing, and the dial-in board may therefore be a single, self-contained, wireless unit (i.e., having no external wiring).

In addition, the LED display is preferably provided with multiple brightness settings (e.g., 6) and with the ability to display the dial-in time in any of multiple (e.g., 7) different desired colors. To provide these features, the LED display and/or control module may, for instance, include multi-colored LED's and a dimmer control circuit capable of providing multi-stage dimming settings. Of course, more or fewer colors or more or fewer dimming settings could be provided within the scope of the present inventive concepts. Furthermore, the display could be dual-sided to permit the digital display on the dial-in board to be viewed from either side (e.g., a front and back side).

A control panel arranged on the dial-in board may provide the user with access to buttons, dials, and/or switches for operating the control module. This can permit the user to, for instance, change stored dial-in times, select between multiple stored dial-in times for display, select a brightness (or dimness) of the display, select a desired display color from multiple color options, and power the dial-in board on and off Alternatively or additionally, the dial-in board may be provided with Bluetooth capabilities that permit it to be accessed and controlled via a Bluetooth-connected device such as a cell-phone or tablet. An app may be provided to permit a user to access and control the features and functions of the dial-in board via their cell-phone or tablet.

A charging port is also preferably included to permit charging of the internal rechargeable battery. Alternatively or additionally, the dial-in board may include solar cells to permit solar charging of the rechargeable battery.

In a preferred embodiment, a digital dial-in board includes a housing having an LED display mounted to the front of the housing. The LED display preferably includes a plurality of multi-colored LED lights arranged to form up to a four-digit number and a decimal point. A control circuit (or “module”) and rechargeable battery are preferably arranged inside the housing and connected to the LED display. A control panel is preferably arranged on the housing to permit a user to operate the digital dial-in board.

The control panel preferably includes a plurality of buttons, dials, and/or switches that allow a user to access and control settings on the control circuit. For instance, the control panel may include an on/off button or switch configured to turn the dial-in board on and off. Additional buttons, dials, or switches may permit a user to select between digits on the display and to then change the displayed number in each of those digits. Another button may permit a user to select one of the dimmer settings to control a brightness of the LED display. Yet another button may permit a user to select between different available colors provided by the multi-colored LED lights. A charge port can be provided along the outside of the housing to receive a charging cable to charge the rechargeable battery. And the housing can further be provided with a mounting face having mounting holes for mounting the dial-in board to a racing vehicle.

Of course, various further aspects, embodiments, and configurations of this invention are possible without departing from the principles disclosed herein. This invention is therefore not limited to any of the particular aspects, embodiments, or configurations described herein but should be interpreted as encompassing all such variations falling within the spirit and scope of the appended claims.

### BRIEF DESCRIPTION OF DRAWINGS

The foregoing and additional objects, features, and advantages of the present inventive concepts will become more readily apparent from the following detailed description of preferred embodiments, made with reference to the accompanying drawings, in which:

FIG. 1 is a somewhat schematic front view of a digital dial-in board according to principles of the present inventive concepts;

FIG. 2 is a somewhat schematic front view if the digital dial-in board of FIG. 1, illustrating the housing and internal components with the front display removed;

FIG. 3 is a somewhat schematic bottom plan view of the digital dial-in board of FIG. 1, illustrating a control panel for controlling operation of the digital dial-in board;

FIG. 4 is a somewhat schematic perspective view of the digital dial-in board of FIG. 1; and

FIG. 5 is a somewhat schematic front view of a Bluetooth module for controlling the digital dial-in board according to another embodiment if the present inventive concepts.

### DETAILED DESCRIPTION OF ILLUSTRATIVE EMBODIMENTS

Various features, benefits, and configurations incorporating the principles of the present inventive concepts in an illustrative embodiment are shown in the accompanying drawings. Additional features, benefits, and configurations will be readily apparent to those of ordinary skill in the art based on this disclosure, and all such features, benefits, and configurations are considered within the scope of the present invention. Various embodiments will now be described in further detail in connection with the accompanying drawings.

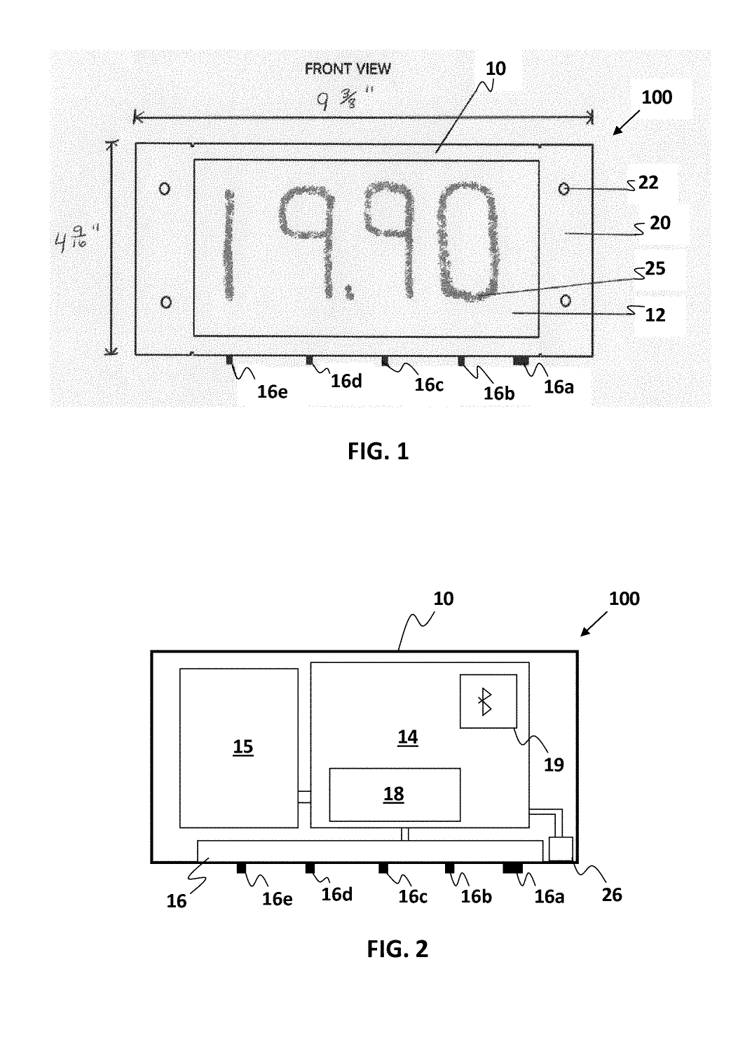

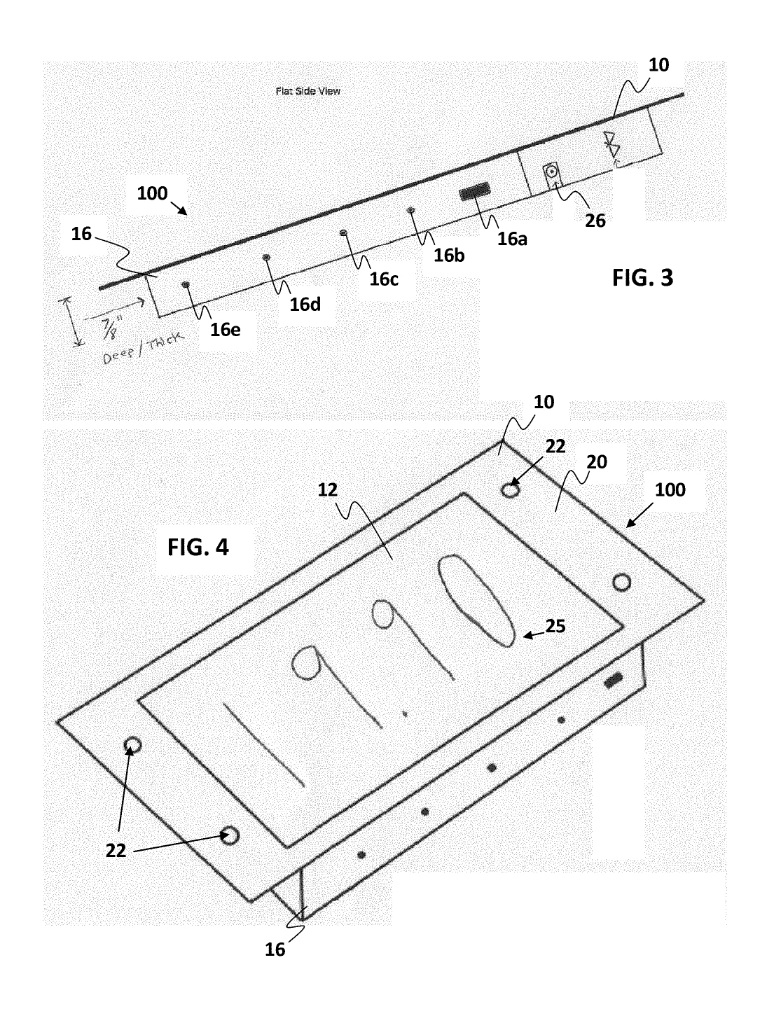

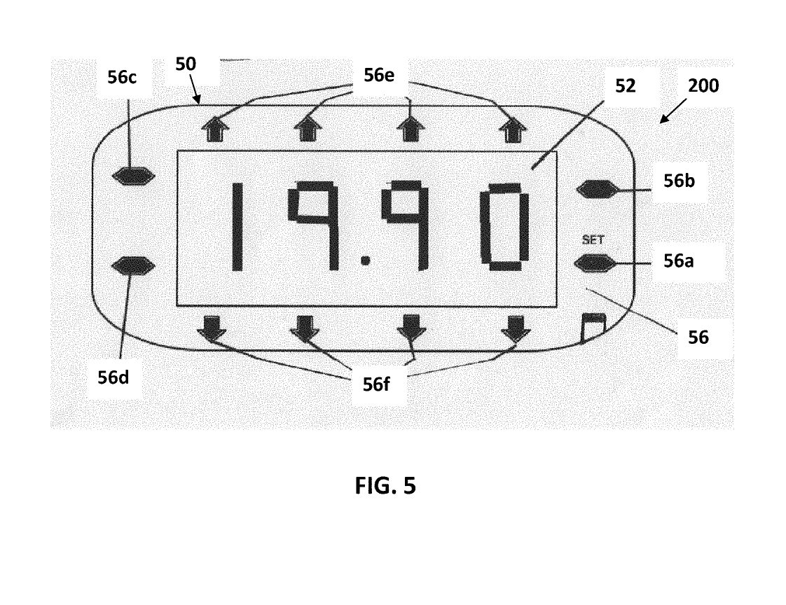

FIG. 1 is a somewhat schematic front view of a digital dial-in board 100 according to principles of the present inventive concepts. FIG. 2 is a somewhat schematic front view if the digital dial-in board 100 of FIG. 1, illustrating the housing and internal components with the front display 12 removed. FIG. 3 is a somewhat schematic bottom plan view of the digital dial-in board 100 of FIG. 1, illustrating a control panel 16 for controlling operation of the digital dial-in board 100. FIG. 4 is a somewhat schematic perspective view of the digital dial-in board 100 of FIG. 1.

Referring to FIGS. 1 through 4, according to an embodiment of the present inventive concepts, a digital dial-in board 100 provides a digital display of a dial-in time on a racing vehicle (not shown) without the need for wiring to the vehicle's power source. Rather than connecting to the vehicles power supply, a digital dial-in board 100 according to principles of these inventive concepts includes a rechargeable battery 15 that can power the dial-in board 100 for a length of time between charges. The charge may, for instance, last up to 8-10 hours or more on a full charge. A digital display 12 and control module 14, according to these inventive concepts, may be contained in a single housing 10, and the dial-in board 100 may therefore be a single, self-contained wireless unit with no external wiring (other than a removeable charging cable).

In a preferred embodiment, the digital dial-in board 100 includes a housing 10 having an LED display 12 mounted to the front of the housing 10. The LED display 12 preferably includes a plurality of multi-colored LED lights arranged to form up to a four-digit number and a decimal point providing the dial-in time 25.

The LED display 12 is preferably provided with multiple brightness settings and with the ability to display the dial-in time 25 in any of multiple different desired colors. The LED display 12 may, for instance, include multi-colored LED's and a dimmer (or dimmer circuit) 18 may be provided on the control module 14 that is capable of providing multi-stage dimming settings. The multi-colored LED display 12 may, for instance, be capable of displaying the dial-in time 25 in seven different colors, and the dimmer 18 may be a six-stage dimmer providing six different dimming (or brightness) settings.

Of course more or fewer colors and more or fewer dimming/brightness settings could be provided within the scope of the present inventive concepts. Furthermore, the digital display 12 could be any type of digital display (i.e., LED, LCD, etc.) and could be dual-sided (using either a single or multiple displays) to permit the digital display 12 on the dial-in board 100 to be viewed from both a front and a back side of the dial-in board 100.

A control module (having a control circuit) 14 and a rechargeable battery 15 are preferably arranged inside the housing 10 and connected to the LED display 12. A control panel 16 may be arranged along the outside of the housing 10 to permit a user to operate the digital dial-in board 100.

The control panel 16 arranged on the dial-in board 100 may provide the user with access to buttons, dials, switches, and/or other features 16a-16e for operating the control module 14. These features can, for instance, permit the user to change stored dial-in times, select between multiple stored dial-in times for display, select a brightness (or dimness) of the display, select a desired display color from multiple color options, and power the dial-in board on and off.

More specifically, in this embodiment, the control panel 16 includes a plurality of buttons, dials, and switches 16a-16e that allow a user to access and control the settings on the control circuit 14. For instance, the control panel 16 includes an on/off button or switch 16a configured to turn the dial-in board 100 on and off. Additional buttons, dials, or switches 16b, 16c permit a user to select between digits on the display and to then change the displayed number in each of those digits. Another button 16d permits a user to select one of the dimmer settings of the dimmer circuit 18 to control a brightness of the LED display 12. Yet another button 16e permits a user to select between different available colors provided by the multi-color LED lights.

A charging port 26 is also provided along the outside of the housing 10 to receive a charging cable (not shown) to charge the rechargeable battery 15. And the housing 10 is further provided with a mounting face 20 having mounting holes 22 for mounting the dial-in board 100 to a racing vehicle. Alternatively or additionally, the dial-in board 100 may include solar cells (not shown) to permit solar charging of the rechargeable battery 15.

The control module 14 of the dial-in board 100 may also be provided with a wireless communications module 19 to provide Bluetooth (or other wireless communications) capabilities that permit it to be accessed and controlled via a Bluetooth-connected device such as a cell-phone or tablet (not shown). An app may be provided to permit a user to access and control the features and functions of the dial-in board via their cell-phone or tablet. Alternatively or additionally, other wireless communications protocols besides Bluetooth could be used to communicate with and control the dial-in board.

FIG. 5 illustrates a wireless control module 200 for wirelessly controlling the digital dial-in board 100 according to further principles of the present inventive concepts. Referring additionally to FIG. 5, a wireless control module 200 may include a control panel 56 arranged on a front of the module 200 with buttons 56a-56f to control the functions of the dial-in board 100. The buttons 56a-56f may be arranged on the front side of the module housing 50 around the module display 52. An on/off button 56c can power the module 200 on and off. Another button 56d can turn on the display 12 of the dial-in board 100 and/or select a color for the displayed dial-in time 25. Buttons 56e, 56f can be provided above and below each digit in the module display 52 to move the number higher or lower, respectively to select the number to display on the dial-in board 100. A button 56b can also be provided to control the dimmer 18 and select a brightness of the display 12. And another button 56a can be used to activate the Bluetooth communication and sync with the dial-in board 100.

Having described and illustrated principles of the present invention in various preferred embodiments thereof, it should be apparent that the invention can be modified in arrangement and detail without departing from such principles.

What is claimed is:

1. A dial-in board for mounting on a racing vehicle, said dial-in board comprising:
a housing containing a digital display and a control module, wherein the control module controls the display of a dial-in time on the digital display;
a rechargeable battery mounted within the housing that powers the digital display and the control module; and
wherein, the dial-in board is configured to be readily mountable and detachable from the racing vehicle without the need for any external wiring.

2. A dial-in board according to claim 1, wherein the dial-in board further includes a control panel arranged on the housing to permit user selection and control of features provided by the control module.

3. A dial-in board according to claim 1, wherein the digital display comprises a multi-colored LED display that is capable of displaying the dial-in time in any of multiple different colors.

4. A dial-in board according to claim 3, wherein the control module is capable of selecting between any of the multiple colors for display of the dial-in time on the multi-colored LED display.

5. A dial-in board according to claim 1, wherein the display is a dual-sided display that displays the dial-in time on both a front and a back side of the dial-in board.

6. A dial-in board according to claim 1, further comprising a dimmer capable of controlling a brightness of the digital display.

7. A dial-in board according to claim 6, wherein the dimmer is a six-stage dimmer that provides six different brightness settings for the digital display.

8. A dial-in board according to claim 1, wherein the control module is capable of Bluetooth communication with an external device, and wherein the external device can be provided with the ability to control the control module through the Bluetooth communication.

9. A dial-in board according to claim 8, wherein the external device comprises an app installed on the external device that permits it to control the control module of the dial-in board.

10. A dial-in board according to claim 1, further comprising solar cells mounted to the housing that are capable of providing power to the rechargeable battery.

11. A dial-in board according to claim 1, further comprising a charging port arranged on the housing for receiving a removeable charging cable capable of charging the rechargeable battery.

12. A portable dial-in board for a racing vehicle, said portable dial-in board comprising:
a digital display configured to display a dial-in time of the racing vehicle;
a control module configured to control the digital display;
a rechargeable battery configured to power the control module and the digital display; and
a portable housing configured to house the digital display, the control module, and the rechargeable battery within a single, self-contained housing unit, and said portable housing further configured to be readily mountable to, and removeable from, the racing vehicle.

13. A portable dial-in board according to claim 12, wherein the digital display comprises a multi-colored LED display capable of displaying the dial-in time in any of multiple different colors.

14. A portable dial-in board according to claim 13, wherein the control module comprises a dimmer capable of adjusting a brightness of the multi-colored LED display.

15. A portable dial-in board according to claim 14, wherein the control module is configured having a Bluetooth communication capability to permit control of the control module via an external device through Bluetooth communication.

16. A portable dial-in board according to claim 14, wherein the dimmer is a six-stage dimmer.

17. A portable dial-in board according to claim 12, wherein the multi-colored LED display is capable of displaying the dial-in time in any of seven different colors.

18. A wireless, portable, self-contained, dial-in board for a racing vehicle, said dial-in board comprising:
a multi-colored LED display capable of displaying a three or four-digit dial-in time of the racing vehicle in any of multiple different colors;
a control module configured to control the multi-colored LED display;
a rechargeable power supply configured to power the multi-colored LED display and the control module; and
a single, portable, self-contained housing unit configured to house the multi-colored LED display, the control module, and the rechargeable power supply and further configured to readily mount to the racing vehicle.

19. A dial-in board according to claim 18, wherein the control module is capable of Bluetooth communication to receive control instructions from an external device.

20. A dial-in board according to claim 18, further comprising a multi-stage dimmer configured to control a brightness of the multi-colored LED display.
